(19) United States
(12) Patent Application Publication
(10) Pub. No.: US 2020/0324235 A1
(43) Pub. Date: Oct. 15, 2020

(54) FILTER MEDIUM WITH NON-WOVEN AS SINGLE-LAYER FIBER COMPOSITE AND METHOD FOR PRODUCING SUCH A FILTER MEDIUM

(71) Applicant: Carl Freudenberg KG, Weinheim (DE)

(72) Inventors: Oliver Staudenmayer, Weinheim (DE); Heiko Schacht, Weinheim (DE); Anhony Hollingsworth, Birkenau (DE); Torsten Gorges, Rodenbach (DE); Alexander Kolew, Frankenstein (DE); Rosemarie Kurzer, Burgen (DE); Armin Greiner, Weinheim (DE)

(21) Appl. No.: 16/842,795

(22) Filed: Apr. 8, 2020

(30) Foreign Application Priority Data
Apr. 10, 2019 (EP) 19 168 408.3

(51) Int. Cl. B01D 39/16; D04H 3/007; D04H 3/02; D04H 3/08

(52) U.S. Cl. CPC B01D 39/1623; D04H 3/007; D04H 3/02; D04H 3/08; B01D 2201/12; B01D 46/521; B01D 2239/0627; B01D 2239/0618; B01D 2239/0622; B01D 2239/0442; B01D 2239/0225

(57) ABSTRACT

A filter medium for filtration of an air stream includes: a non-woven having a plurality of bicomponent fibers. The non-woven includes a single-layer fiber composite having a first structure of bicomponent fibers and a second structure of continuous bicomponent fibers. The second structure engages with the first structure. In an embodiment, the bicomponent fibers include at least two polymer components. The at least two polymer components of the bicomponent fibers differ in melting point by at least 15 degrees and have a cover-core fiber structure or a side-by-side fiber structure.

### CROSS-REFERENCE TO PRIOR APPLICATION

Priority is claimed to European Patent Application No. EP 19 168 408.3, filed on Apr. 10, 2019, the entire disclosure of which is hereby incorporated by reference herein.

### FIELD

The invention relates to a filter medium with non-woven and a method for producing such a filter medium.

### BACKGROUND

Pleated, i.e. folded, filter media are generally known for their use in many filter elements and serve to increase the filtration surface. In order to obtain pleatable and thus inherently rigid media which retain the shape of the folds and to obtain the corresponding filtration performance, the materials are usually equipped with multiple layers. Backing layers for synthetic-fiber-based materials are usually very stable spun-bonded non-wovens or staple-fiber non-wovens which consist of PES fibers or polyolefin fibers. In some embodiments, the fibers used can be in the form of bicomponent fiber structures. Thermally bonded bicomponent structures normally result in higher rigidities than do homopolymer fibers. While the backing layer consists of coarse spun or staple fibers and substantially has a supporting function or stiffening/pleating function, the deposition of fine particles is produced by microfibers which are applied to the backing layer. The microfiber layer cannot provide support on its own and has insufficient rigidity.

The microfiber layer is in part additionally protected with a cover laminated thereon. The microfibers are composed, for example, of polypropylene or of polycarbonate polymer. Depending on the type of polymer and process used, the microfibers are often in addition electrostatically charged.

A common filter material for the application mentioned at the outset thus consists of a rigid spun-bonded non-woven layer with coarse fibers produced by the spun-bonded non-woven process and a fine microfiber layer produced by the meltblown process. These two layers are bonded to each other, for example by an ultrasonic calendering process. Structures and processes of this type are known, for example, from WO 2010/049052 or EP 1208 959 B1. Alternatively, the layers are also laminated, for example by means of hot-melt or spray adhesives. In addition to the combination of carrier structures, for example by means of spun-bonded non-wovens with microfibers, composites of staple fibers with a carrier structure are also known. These composites with staple fibers are well-suited to facilitating a high dust-holding capacity and thus a long service life of the filter. Often used in this case are triboelectrically charged fibers, which are then laminated with a carrier on account of their limited non-woven strength or lack of rigidity. This lamination is often effected, for example, by ultrasound, needles or bonding by means of a hot-melt adhesive. Common to all these embodiments is the fact that they are laminates comprising at least two different layers with different fibers/fiber diameters. In practice, such composites repeatedly lead to disruptions to the process during pleating, i.e. folding of the filter material, due to the two layers detaching from each other or becoming entangled during pleating. Separation of the layers in the filter element is often evident, which leads to the formation of “pockets” or the formation of small folds in the composite matrix. Due to the disruption to the flow, said folds have a negative effect on the pressure loss of a filter cassette in which the filter medium is inserted.

### SUMMARY

In an embodiment, the present invention provides a filter medium for filtration of an air stream, comprising: a non-woven comprising a plurality of bicomponent fibers, wherein the non-woven comprises a single-layer fiber composite having a first structure of bicomponent fibers and a second structure of continuous bicomponent fibers, and wherein the second structure engages with the first structure.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 a sectional view of a filter medium according to the prior art

FIG. 2 a sectional view of a filter medium according to the invention

FIG. 3 a filter element.

### DETAILED DESCRIPTION

In an embodiment, the present invention provides a filter medium which combines good stability, processability and dust holding capacity and at least partially eliminates the disadvantages of the prior art. A further object is to describe a method for producing such a filter medium.

The filter medium requires a high degree of rigidity so that it can be pleated easily and on an industrial scale, i.e. set in folds. It is advantageous for the pressure loss of the filter medium if the material is relatively thin. When the media are as thin as possible, the spacing of the pleats can be reduced in order thereby to reduce the pressure loss of the filter element. At the same time, it is advantageous, with comparable pressure loss of the cassette, to achieve the highest possible dust-holding capacity in a cassette by adjusting material thickness, air permeability and non-woven construction. High dust-holding capacity means a long service life. In order to save costs, the aim is simultaneously to introduce as low a weight per unit area or filter medium quantity as possible.

According to the invention, it has been found to be advantageous to provide a filter medium made of a non-woven having a single layer, in which all of the fibers are bound to one another, i.e. form a fiber composite.

The filter medium according to the invention serves to filter an air stream and comprises a non-woven with a multiplicity of bicomponent fibers. According to the invention, the non-woven is formed as a single-layer fiber composite having a first structure of bicomponent fibers and a second structure of continuous bicomponent fibers, wherein the second structure engages with the first structure in that the first structure is spun with the second structure.

The first structure, together with the stretched fibers of the second structure, provides a very stable, single-layer material with surprisingly high rigidity, very high air permeability and high dust-holding capacity with good filtration effect.

In a particularly advantageous and therefore preferred development of the filter medium according to the invention, the bicomponent fibers are composed of at least two polymer components whose melting point differs by at least 15 degrees and have in particular a cover-core fiber structure or a bilateral side-by-side fiber structure. The preferred polymer of cover and core (or side-by-side) is polypropylene, but polyester can also be used especially in the core of the fiber. The proportion of the two components of cover and core (or side-by-side) may vary between 9:1 and 1:1, with 8:2 and 7:3 being preferred. Here the smaller proportion is the lower melting component.

It is particularly advantageous if the polymer components of the bicomponent fibers consist of polyolefins, for example of polypropylene (PP).

It has been found to be advantageous that the polymer types correspond to the low-melting polymer component of the bicomponent fibers of the first and second structures in order to ensure material uniformity, i. e. the low-melting polymer component of the bicomponent fibers of the first and second structures are similar polymers.

In the filter medium according to the invention, the bicomponent fibers of the first structure can be embodied as staple fibers, as spun-bonded non-woven filaments, as a combination of these technologies and optionally together with meltblown filaments.

It is particularly preferred if the first structure is thermally, mechanically or chemically hardened.

The first structure is understood to be a fibrous textile fabric made of synthetic fibers, which can be hardened thermally, mechanically or by means of binders. The non-woven of the first structure can be produced according to different sufficiently well-known methods or a combination of different methods: spun-bonded non-wovens, meltblown non-wovens, composites of spun-bonded non-wovens with meltblown, dry-laid non-woven of staple fibers, wet non-woven made of staple fibers, combinations of backing materials with nanofibers or the particular combination of the different technologies. These different non-woven production processes are sufficiently well-known to the person skilled in the art and are therefore not described. Specifically conceivable here are also multilayer non-woven structures of coarse fibers (>1 dtex) and finer fibers (e.g. microfibers <1 dtex) for use as the first structure.

In order to enable a progressive construction of the filter medium, the bicomponent fibers of the first and second structures may have different fiber diameters.

It has been found to be advantageous for the first structure to be at least 30 wt %, in particular at least 50 wt % bicomponent fibers (wt % means percent by weight).

In a development of the filter medium, the first structure is provided with electret functionality, antimicrobial finishing and/or coloration. Fibers composed of polypropylenes can, for example, be permanently electrostatically charged particularly well. This can be done, for example, via a corona charge. Other methods for introducing electrostatic charge are also conceivable.

The first structure of the filter medium may have a weight per unit area of 20 to 150 g/m² in particular of 40 to 80 g/m².

The continuous spun-bonded non-woven fibers, which are applied to the previously provided non-woven fabric, consist inter alia of bicomponent fibers. These fibers consist of at least two polymer components. These can be cover-core or side-by-side fiber structures. The preferred polymer of cover and core (or side-by-side) is selected from the group of polyolefins. By polyolefins we mean polymers prepared from alkenes. Typical but non-limiting examples of these polymers are polypropylenes, polyethylene or copolymers thereof.

In one embodiment variant, however, PES can also be used in the core of the fiber. The two polymers of cover and core used (or alternatively of side-by-side) differ in their melting point by at least 15° C. The proportion of the two cover and core (or side-by-side) components may vary between 9:1 and 1:1, with 8:2 and 7:3 being preferred. The smaller proportion is the lower melting component. The weight per unit area of the continuous spun-bonded non-woven fibers or filaments is 15 to 150 g/m², preferably 40 to 80 g/m².

If the composition of the non-woven provided has an asymmetrical construction, the continuous spun-bonded non-woven fibers can, depending on the desired property profile, be applied to different sides of the non-woven fabric provided.

The invention also relates to a method for producing a filter medium as described above, comprising the following steps:
(a) Production of the first structure
(b) Feeding the first structure into a spun-bonded non-woven plant
(c) Spinning the first structure with a second structure to create a single-layer fiber composite.
(d) Hardening the fiber composite

In a further development of the method, in step (d) the fiber composite can be pressed and/or thermally bonded and/or thermally calibrated and/or post-treated.

In other words: a non-woven, which contains bicomponent fibers, is provided to a spun-bonded non-woven plant. This provided non-woven fabric is spun with continuous spun-bonded non-woven fibers, which likewise take the form of bicomponent fibers. This fiber composite is subsequently pressed, thermally bonded or thermally calibrated and optionally post-treated. The freshly spun continuous spun-bonded non-woven fibers or the fluid polymer penetrates very easily into the provided non-woven layer during thermal hardening. Surprisingly, a very intensive fiber-to-fiber bonding arises and results in a single-layer fiber composite after thermal treatment. As a result of the good penetration of the stretched polymer, it is easy to produce a very compact rigid, thin, single-layer non-woven with a relatively open fiber structure, which can additionally be constructed from different fiber types and fiber diameters. This results in simple possibilities for a progressive non-woven structure of the fiber composite.

During the production of a filter medium, the second structure can be spun onto one or both sides of the first structure in step (c).

The invention also relates to a filter element comprising a filter medium as described above, which is preferably pleated, in particular for a filter cassette. The filter media according to the invention and the filter elements produced therefrom can be used predominantly in the field of air filtration, especially in the interior of a vehicle, in air-conditioning systems, in the air filtration of interior spaces in buildings or rooms of all types by means of stationary and/or mobile filter systems, filter elements for vacuum cleaners, in trains or agricultural machines and in the filtration of air in technical processes, such as gas turbines, painting lines or food processing, to give only a few examples.

The invention also relates to the use of such a filter element as a particle filter. The filter media according to the invention are particle filter media and can be used as pure particle filters or in combination with other filter media, for example adsorbent media, as a component of a filter element. The filter medium can be pleated, i.e. folded, in order to increase the filtration surface.

In the case of adsorbent materials, the adsorption layer can be deposited on the downstream side or a reverse sequence is also possible. This embodiment makes it possible to adsorb not only particles but also unpleasant odors.

Against this background, the adsorption layer could comprise activated-carbon particles. The filter medium could have an adsorption layer of activated carbon, zeolites or ion exchangers or mixtures thereof. As a result, harmful gases, such as hydrocarbons, SO₂, NOx, aldehydes, ammonia, VOC or similar gases can be adsorbed.

The activated carbon particles are preferably adhesively bonded to the single-layer material according to the invention using a materially integral hot-melt adhesive.

The weight per unit area of the adsorption layer could be 50 to 500 g/m² and its thickness could be 0.7 to 3.0 mm. A filter medium having the single-layer material according to the invention and an adsorption layer can be used, in particular in the folded state, as a combination filter which adsorbs particles and harmful gases.

The described invention and the described advantageous developments of the invention, even in combination with one another insofar as this is technically sensible, also constitute advantageous developments of the invention.

Reference is made to the dependent claims and the description of exemplary embodiments, with reference to the accompanying figures, with regard to further advantages and embodiments of the invention that are advantageous from a design and functional standpoint.

### Exemplary Embodiment

The following materials serve as possible examples of the single-layer filter medium according to the invention, for use as a pure particle filter or in combination with one or a plurality of adsorption systems as combination filters:

Example A: A 65 g/m² non-woven (A1) consisting of 100% 28 μm PP bicomponent fibers (core melting point 166° C.; cover melting point: 145° C.) and a thickness (DIN EN ISO 9073-2 10 cm², 12.5 cN/cm²) of 1.09 mm, an air permeability (test device: Textest 3000 20 cm², at 200 Pa, DIN ISO 9073-15) of 6390 l/m² s and a low flexural strength (ISO 2493, Frank, Type 58565, 20×100 mm) of 0.15 Nmm in the longitudinal direction and 0.16 Nmm in the transverse direction is provided as the first structure of a spun-bonded non-woven system and spun with 78 g/m² of 100% continuous PP bicomponent fibers as the second layer (B2). These fibers have a core melting point of 166° C. and a cover melting point of 145° C. They have a fiber titer of 30 μm.

After calibration of the composite consisting of the first structure and second structure, it is hardened by means of hot air, thermally calibrated again to the target thickness and electrostatically charged by means of corona.

A spun-bonded non-woven comprising 138 g/m² 100% PP bicomponent fibers serves as reference, analogous to the above experiments. These fibers are calibrated with a titer of 30 μm, hardened by means of hot air, calibrated again to target thickness and electrostatically charged by means of corona. The operational mode of this spun-bonded non-woven in the system corresponds to the operational mode of the example according to the invention.

As shown in Table 1, the invention provides a single-layer fiber composite with significantly increased rigidity, strength and air permeability at the same weight per unit area.

TABLE 1

| | | Reference non-woven | Inventive non-woven |
|---|---|---|---|
| | Measuring method | (single-layer) | (single-layer Example A) |
| Weight per unit | | 138 | 138 |
| area [g/m²] | | | |
| Thickness [mm] | DIN EN ISO 9073-2 | 0.67 | 0.8 |
| | 10 cm², 12.5 cN/cm² | | |
| Air permeability | Test device Textest | 1550 | 2220 |
| [I/m²g] | 3000 20 cm², 200 Pa | | |
| | DIN ISO 9073-15 | | |
| Flexural strength | ISO 2493 | Longitudinal 1.2-1.4 | Longitudinal 1.6-1.8 |
| [Nmm] | Frank | Transverse 0.6-0.7 | Transverse 0.8-0.9 |
| | Type 58565 | | |
| | 20 × 100 mm | | |
| Maximum tensile | EN 29073-03 | Transverse 230 | Transverse 250 |
| force [N/5 cm] | 200 mm/min | Longitudinal 504 | Longitudinal 550 |
| Maximum tensile | EN 29073-03 | Transverse 65 | Transverse 60 |
| force [%] | 200 mm/min | Longitudinal 64 | Longitudinal 55 |

The reference non-woven and the non-woven according to the invention from Example A are processed into a filter element and subjected to filtration measurements. In both cases, the filter element measures 182×254 mm.

The folded filter material has a fold height of 35 mm. The filter element consists of 51 double folds with a fold spacing of 5 mm. 0.51 m² filter surface are incorporated. The pressure loss between the upstream and downstream sides of the filter element is checked with different volume flows in accordance with DIN 71460.

The filter elements are additionally dusted with AC coarse test dust in accordance with DIN 71460 Part 1 and the amount of dust absorbed is determined with a pressure loss increase of 200 Pa. The amount of dust held is a measure of the lifespan of the filter and a larger amount is preferred. The fractional deposition efficiency was determined in accordance with DIN 71460 Part 1 by means of AC fine.

In the filter element according to the invention, the provided non-woven A was measured once on the upstream side and the spun fiber layer B was streamed against once. In both cases, with comparable deposition behavior, a significantly higher dust-holding capacity with similar pressure loss results between the upstream and downstream sides of the filter cassette (see Table 2).

TABLE 2

| | | | Inventive non-woven Example A | |
|---|---|---|---|---|
| | | Reference non-woven | Upstream | Upstream spun |
| | | Example A | non-woven A1 | fiber layer B2 |
| Filter element | 100 m³/h | 7.7 | 7 | 7.5 |
| pressure loss | 200 m³/h | 18.5 | 16.5 | 19.6 |
| [Pa] | 360 m³/h | 41.5 | 38.5 | 32.5 |
| | 600 m³/h | 88 | 85 | 93 |
| Dust-holding | | 46 | 53 | 68 |
| capacity | | | | |
| AC coarse [g] | | | | |
| Fractional | % | >90 | >90 | >90 |
| deposition | | | | |
| efficiency | | | | |
| AC fine 300 | | | | |
| m³/h with 1 μm | | | | |
| particle size | | | | |

Example B: A 45 g/m² non-woven (D1) consisting of 100% 28 μm PP bicomponent fibers (core melting point 166° C.; cover melting point: 145° C.) and a thickness of 0.67 mm (DIN EN ISO 9073-2 10 cm², 12.5 cN/cm²), and a very slight flexural strength (ISO 2493, Frank, Type 58565, 20×100 mm) of 0.07 Nmm in the longitudinal direction and 0.08 Nmm in the transverse is provided as the first structure of a spun-bonded non-woven system and spun with 78 g/m² of 100% continuous PP bicomponent fibers as the second layer (B2). These fibers have a core melting point of 166° C. and a cover melting point of 145° C. They have a fiber titer of 30 pm.

After calibration of the composite comprising the provided non-woven and spun fibers, it is hardened by means of hot air, thermally calibrated again to the target thickness and electrostatically charged by means of corona. A spun-bonded non-woven comprising 138 g/m² 100% PP bicomponent fibers serves as reference, analogous to the above experiments. These fibers are calibrated with a titer of 30 μm, hardened by means of hot air, calibrated again to target thickness and electrostatically charged by means of corona. The operational mode of this spun-bonded non-woven in the system corresponds to the operational mode of the example according to the invention.

As shown in Table 3, the invention provides a single-layer fiber composite with high air permeability, a significant increase in flexural strength compared to the starting material, and with a higher weight per unit area in comparison with a reference product. Table 4 shows a high dust-holding capacity of the filter element for these filter media according to the invention with a lower pressure loss compared to the reference material, which has a high weight per unit area and thus should actually have a higher dust-holding capacity.

TABLE 3

| | | Reference non-woven | Inventive non-woven |
|---|---|---|---|
| | Measuring method | (single-layer) | (single-layer Example B) |
| Weight per unit | | 138 | 116 |
| area [g/m²] | | | |
| Thickness [mm] | DIN EN ISO 9073-2 | 0.67 | 0.75 |
| | 10 cm², 12.5 cN/cm² | | |
| Air permeability: | Test device Textest | 1550 | 2360 |
| [I/m²g] | 3000 20 cm², 200 Pa | | |
| | DIN ISO 9073-15 | | |
| Flexural strength | ISO 2493 | Longitudinal 1.2-1.4 | Longitudinal 0.7 |
| [Nmm] | Frank | Transverse 0.6-0.7 | Transverse 0.4 |
| | Type 58565 | | |
| | 20 × 100 mm | | |
| Maximum tensile | EN 29073-03 | Transverse 230 | Transverse 164 |
| force [N/5 cm] | 200 mm/min | Longitudinal 504 | Longitudinal 350 |
| Maximum tensile | EN 29073-03 | Transverse 65 | Transverse 46 |
| force [%] | 200 mm/min | Longitudinal 64 | Longitudinal 54 |

TABLE 4

| | | | Inventive non-woven Example B | |
|---|---|---|---|---|
| | | Reference non-woven | Upstream | Upstream spun |
| | | Example A | non-woven A1 | fiber layer B2 |
| Filter element | 100 m³/h | 7 | 4 | 4 |
| pressure loss | 150 m³/h | 12 | 7 | 7 |
| [Pa] | 300 m³/h | 27 | 19 | 18 |
| | 600 m³/h | 69 | 54 | 54 |
| Dust-holding capacity | | 50 | 64 | 67 |
| SAE coarse [g] | | | | |

The invention will now be explained in more detail using the accompanying figures. The following are shown:

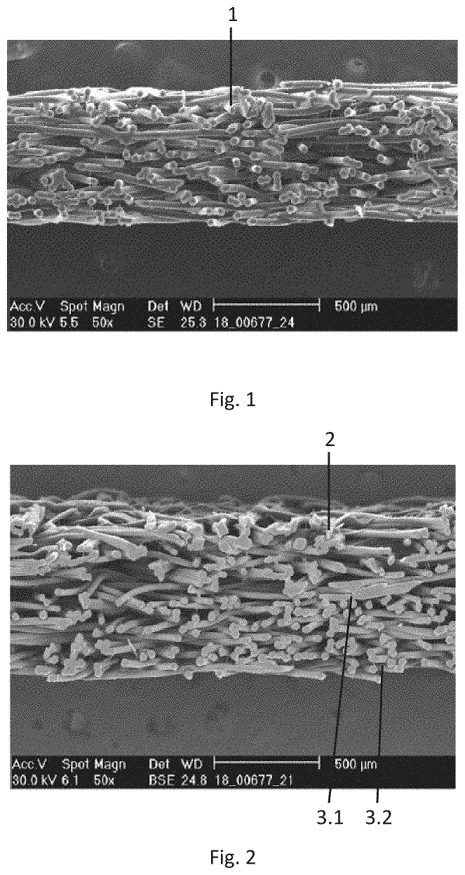

FIG. 1 shows a sectional view of a filter medium 1 according to the prior art.

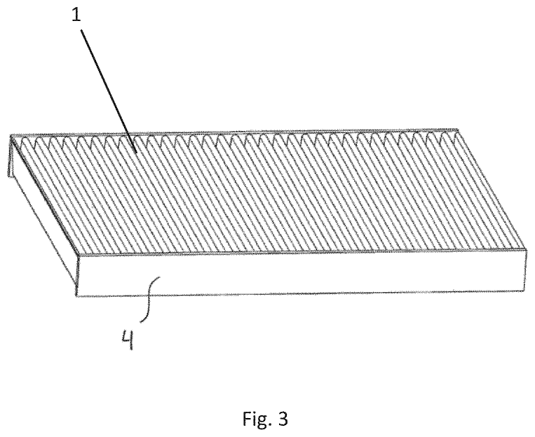

FIG. 2 shows a sectional view of a filter medium 1 according to the invention. The filter medium 1 has a non-woven as a single-layer fiber composite 2. The fiber composite 2 has a first structure 3.1 of bicomponent fibers and a second structure 3.2 of continuous bicomponent fibers, wherein the second structure 3.2 engages with the first structure 3.1 by spinning the first structure 3.1 with the second structure 3.3.

FIG. 3 shows a filter element 4 with a pleated filter medium 1.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Filter medium
2 Fiber composite
3.1 First structure
3.2 Second structure
4 Filter element

What is claimed is:

1. A filter medium for filtration of an air stream, comprising:
a non-woven comprising a plurality of bicomponent fibers,
wherein the non-woven comprises a single-layer fiber composite having a first structure of bicomponent fibers and a second structure of continuous bicomponent fibers, and
wherein the second structure engages with the first structure.

2. The filter medium according to claim 1, wherein the bicomponent fibers comprise at least two polymer components, and
wherein the at least two polymer components of the bicomponent fibers differ in melting point by at least 15 degrees and have a cover-core fiber structure or a side-by-side fiber structure.

3. The filter medium according to claim 2, wherein polymer types correspond to a low-melting polymer component of the bicomponent fibers of the first and second structures.

4. The filter medium according to claim 1, wherein the bicomponent fibers of the first and second structures have different fiber diameters.

5. The filter medium according to claim 2, wherein the polymer components comprise polyolefins.

6. The filter medium according to claim 1, wherein the bicomponent fibers of the first structure comprise staple fibers, spun-bonded non-woven filaments, or meltblown filaments.

7. The filter medium according to claim 1, wherein the first structure is thermally, mechanically, or chemically hardened.

8. The filter medium according to claim 1, wherein the first structure comprises at least 30 wt % bicomponent fibers.

9. The filter medium according to claim 1, wherein the first structure comprises an electret functionality, an antimicrobial finish, and/or a coloration.

10. The filter medium according to claim 1, wherein the first structure has a weight per unit area of 20 to 150 g/m².

11. A method for producing the filter medium according to claim 1, comprising the following steps:
(a) producing the first structure;
(b) feeding the first structure into a spun-bonded non-woven plant;
(c) spinning the first structure with a second structure to form a fiber composite;
(d) hardening the fiber composite.

12. The method for producing a filter medium according to claim 11, wherein in step (d) the fiber composite is pressed and/or thermally bonded and/or thermally calibrated and/or post-treated.

13. The for producing a filter medium according to claim 11, wherein in step (c) the second structure is spun onto one or both sides of the first structure.

14. A filter element, comprising:
the filter medium according to claim 1,
wherein the filter medium comprises a pleated form, and
wherein the filter element is for a filter cassette.

15. A method of using the filter element according to claim 14 as a particle filter for filtration of air.

16. The filter medium according to claim 8, wherein the first structure comprises at least 50 wt % bicomponent fibers.

17. The filter medium according to claim 10, wherein the first structure has a weight per unit area of 40 to 80 g/m².
